(19) United States
(12) Patent Application Publication
(10) Pub. No.: US 2005/0206178 A1
(43) Pub. Date: Sep. 22, 2005

(54) Auxiliary handle & hinge assembly for shovels

(76) Inventor: William John Hoeft, Green-Bay, WI (US)

Correspondence Address: WILLIAM J HOEFT, 1238 KLAUS ST., GREEN-BAY, WI, 54302, US

(21) Appl. No.: 10/805,605

(22) Filed: Mar. 22, 2004

(51) Int. Cl. A01B 1/22

(52) U.S. Cl. 294/58

(57) ABSTRACT

An auxiliary handle hinge assemby for shovels with a fixed or adjustible auxiliary length handle to connect to the shaft near the blade end of the shaft, the assembly can be raised by making the base template plate to be clamped to the shaft by bending two 90 degree angles and clamping the assembly to the shovel main shaft, or it can be bolted directly to the shovel main shaft where it would be shorter in length than the optional clamped hinged assembly. The auxiliary handle is secured to the main handle by ceramic magnet on the main handle, and a magnetic attraction metal bolted to the auxiliary handle. The hinge is bolted to the base template plate by one bolt, it becomes a swivel plate, if you use two bolts on the hinge it becomes a non-swivel hinged assembly, in the swivel mode the hinge can rotate in any direction, other than counter clockwise of clockwise, which stabilizes the wrist in the lift mode, and the auxiliary handle lessens back stress during the lifting process.

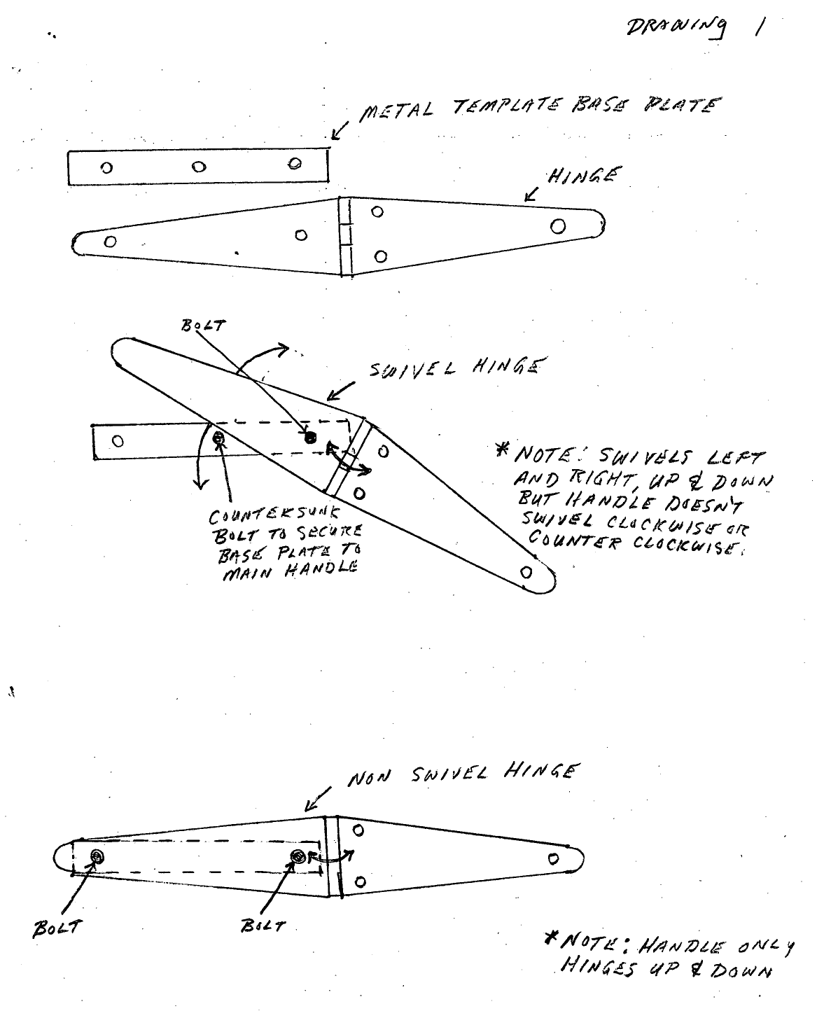

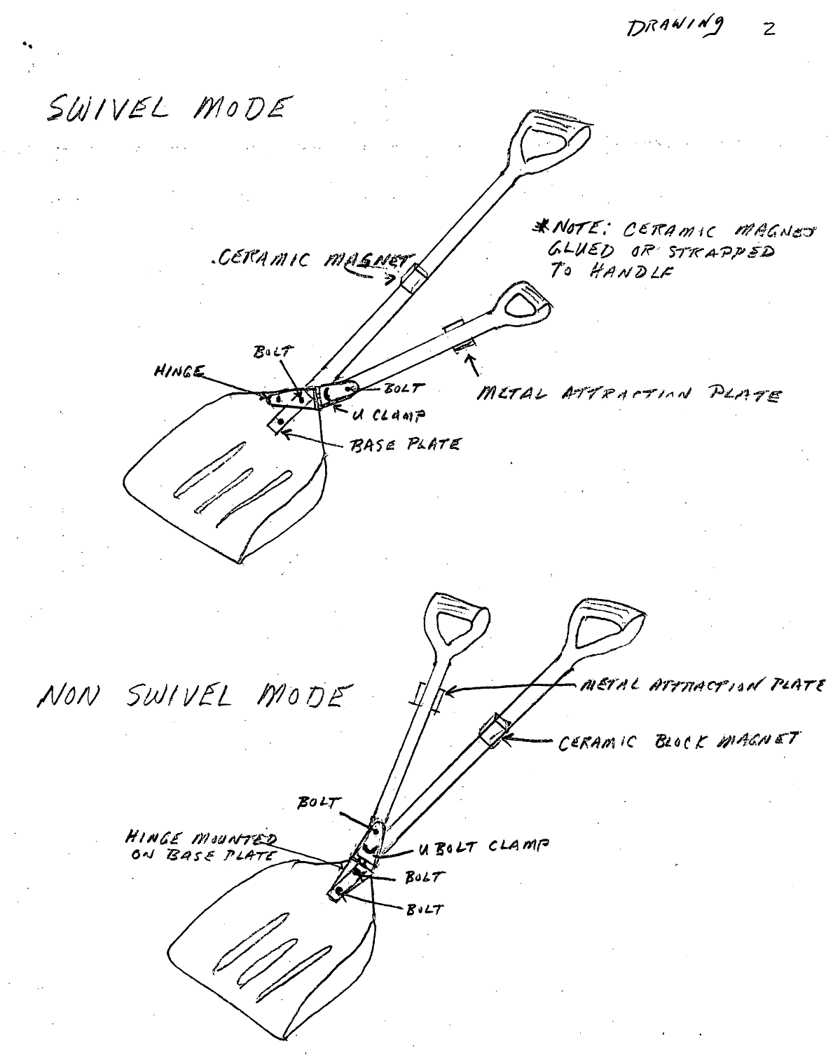

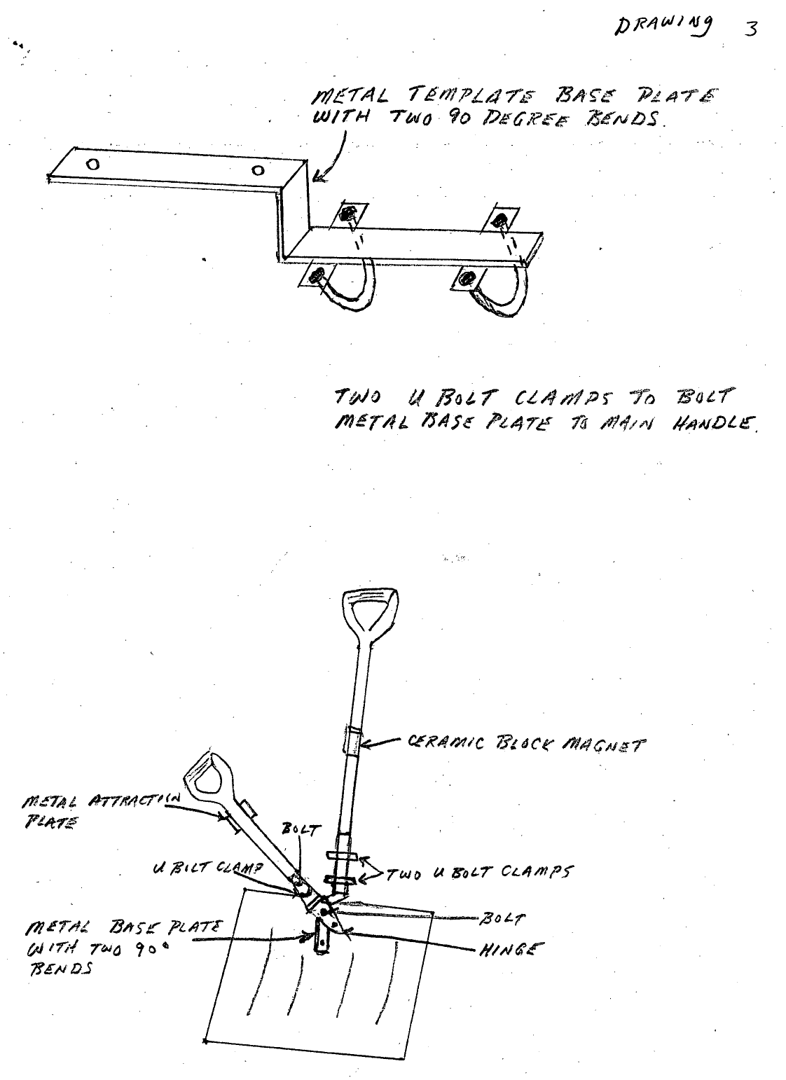

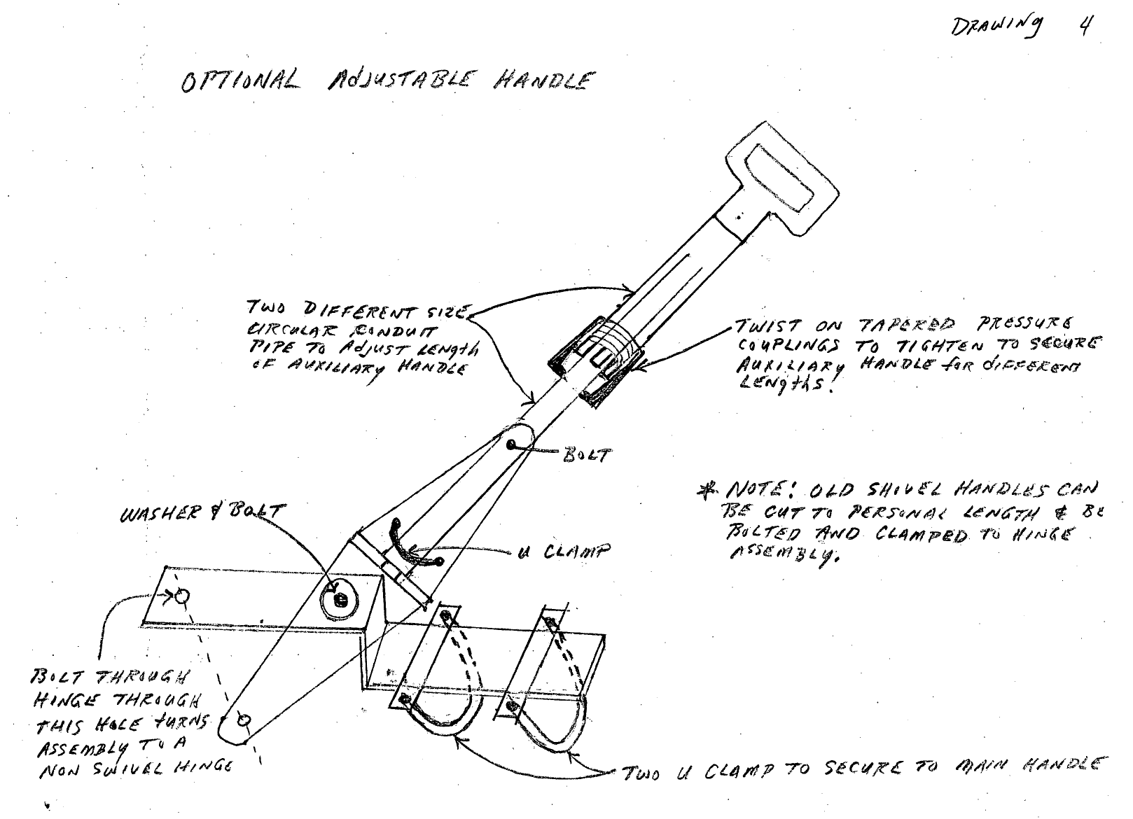

### U.S. PATENT DOCUMENTS

| | | | |
|---|---|---|---|
| 161678 | Apr. 1875 | Gardner | 294/58. |
| 911291 | Feb. 1909 | Byor | 294/58. |
| 1151012 | Aug. 1915 | Herringstad | 294/58. |
| 1456879 | May 1923 | Newman | 294/58. |
| 1586056 | May 1926 | Walsh | 294/58. |
| 4050728 | Sep. 1977 | Davidson | 294/58. |
| 4200324 | Apr. 29, 1980 | Helton | 294/58. |
| 4229033 | Oct. 21, 1980 | Vosbikian | 294/58. |
| 4264096 | Apr. 28, 1981 | Barnett | 294/58. |
| 4615553 | Oct. 7, 1986 | Hultine | 294/58. |
| 4944541 | Jul. 1990 | Waldschmidt | 294/58. |
| 5133582 | Jul. 28, 1992 | Rocha | 294/58. |
| 5411305 | Mar. 2, 1995 | Revoldt | 294/58. |
| 5431468 | Jul. 11, 1995 | Rosenshine | 294/58. |
| 5447349 | Sep. 5, 1995 | Coble | 294/58. |
| 5704672 | Jan. 6, 1998 | Sims | 294/58. |
| 5921600 | Jul. 13, 1999 | Lucas | 294/58. |
| 6062619 | May 16, 2000 | Clark Jr. | 294/58. |
| D441623 | May 8, 2001 | Storlie | 294/58. |
| 6343822 | Feb. 5, 2002 | Badura | 294/58. |

This invention in the field of digging tools. Its related to the lifting tools that cause back strain with their excessive use thereof, includes shovels, scoops, forks, and push brooms, including other digging, and lifting tools, ect. . . .

### SUMMARY OF THE INVENTION

The invention allows reuse of discarded shovel handles, by cutting them to desired length, and clamping to the swivel, non-swivel adjustable hinge, or attaching an adjustable axiliary handle by sliding different conduit diameter to slide inside the other and be coupled with a compression tapered tightening coupling connection, to make the auxiliary handle length adjustable. The ceramic magnets bring it all together, allowing the user to not to need to have his second hand on the auxiliary handle at all times, during use thereof, providing fluidity of the auxiliary handle, so the handle is not flopping around, you simply reach for the handle and lift, and set auxiliary handle on ceramic magnet, this frees up the users second hand when pushing snow, digging with a spade shovel, carrying, storing, etc. . . .

### OBJECTS OF THE INVENTION

The object is to provide the auxiliary handle to move in two directions in the non-swivel mode, and to move in 4 directions in swivel mode, the base plate stablilized the handle so its unable to move counterclockwise or clockwise, this supports the wrists in the lift mode, yet providing more lateral flexiblity in the swivel mode. The Auxiliary handle allows the user to be in a more upright position, in either the swivel or non-swivel mode, lessening back related stresses.

The non swivel auxiliary handled shovels can create side lateral stresses on the back, this hinged assembly allows the user to have the option to use the swivel mode, to lessen the side related stresses. It allows the user the option to switch to whatever preference they desire, for whatever kind of shovel, or impliment they attach the assembly to.

An auxiliary handle can be made to be capable to be adjusted quickly to various lengths, by a simple tapered pressure compression threaded twist joint, to connect two different sized conduit, allowing different users to adjust auxiliary handle quickly to a comfort length. It also allows one to cut an old shovel handle and clamped to hinge assembly, by recycling old handles, its a cost savings to buyer.

### DESCRIPTION OF THE DRAWINGS

Drawing 1) Is a perspective of the basic metal base plate template, that the hinge mounts onto, in respect to the swivel and non-swivel mode of operation. This base plate is secured by a counter sunk bolt, to secure the base plate to the main handle. The bolt that provides the swivel joint needs either a cotter key, or if threaded to use a lock nut, with a bit of thread glue. In the swivel mode the base plate restricts movement so the handle doesn't rotate counterclockwise, or clockwise, in the non-swivel mode the handle only moves up and down.

Drawing 2) Is a perspective of an elongated metal base plate template, that has two 90 degree bends, allowing the base plate to be clamped to the shovel with two U bolt clamps, with a metal attraction plate and a ceramic magnet to secure the auxiliary handle to main handle. The picture shows a common show shovel, in the swivel mode, this elongated metal base plate, can be made into a non-swivel mode by bolting the hinge to the base plate with a second bolt.

Drawing 3) Is a perspective of the metal base plate bolted directly to a shovel, in the swivel and non swivel mode, with the metal attration plate and ceramic magnet to secure the auxiliary handle. This shows that on the common snow scoop shovel, that the best base plate is the one that requires three holes to be drilled through the shovel, so the base plate can be bolted into the center hole, and the hinge bolted into either the swivel or non-swivel mode. It shows the ceramic magnets on the main shovel handle, and the magnetic attraction plate on the auxiliary handle.

Drawing 4) Is a perspective of an adjustable handle, using the elongated base template plate, though handle could be installed on the basic base template plate, to make an adjustable handle using two different diameter conduit pipes so they slide one in the other, and the use of a tapered compression threaded twist pressure joint that allows the auxiliary handle length to be tightened to different lengths, quickly, by lossening and retightening this tapered pressure coupling.

### DESCRIPTION OF THE INVENTION

In conventional shovels, pitchforks, scoops, manure forks, snow shovel, snow pushers, push brooms, shares a benefit by an auxiliary handle, the permanent magnets attached to the handles makes the auxiliary handle secured while using, but able to use to lift and resecure without clamps, facilitating the use thereof, not requiring your second hand to always need to be attached to the second handle, this is an impovement where one can dig the spade shovel, and when you just grab the second shovel handle when its time to lift, when pushing snow you don't need to have your second hand on the auxiliary handle until its time to lift, when carrying the shovel, you don't need to pin the second handle to move or store, the permanent magnets allows second handle to not flop all over the place, when using, or carrying, or storing, this is a big negative on second handle shovels, when using one needs to have a second hand on the second handle to control it, the magnets control the auxiliary handle when using giving you a third hand, so you can concentrate at the task at hand, the auxiliary handle is alway there to grab and lift, a big improvement in functionability, fluidity, no spring returns pin latches needed, or stationary pins needed to control the second handle when not in use, etc. . . .

I created a base plate template principle, so the hinge can be adjusted to be either a swivel hinge, or a non-swivel hinge, the basis of the base plate is two fold, one is to act as a template so the hinge can operate as a swivel hinge, with a second bolt through the hinge secured to the baseplate, it becomes a non swivel hinge. The second part of the base plate is to provide some support to the wrist on the auxiliary handle, so the weight of the load doesn't swivel the wrists when lifting the load, because the hinges only swivel left and right, and up and down, the handle doesn't swivel in a clockwise or counter clockwise direction, this complements the wrists, for people with lower back problems, it provides some lateral flexibilities, on the wider snow scoops, the swivel hinge, lessening the stresses associated with the lateral back side related muscles that the non swivel hinge can impart, allows the user the option to make the auxiliary handle a swivel or a non-swivel hinge, and this is matter of personal preferences.

The auxiliary handle with the base plate that is clamped to the handle with clamps, one can either cut the auxiliary handle length to personal preference, and micro-adjust the position of the base plate to make the auxiliary handle length more comfortable, the handle normally should be adjusted to allow when standing with the arm straight bearing the load that the auxiliary handle it clears the ground, so you can swing, the shovel like a pendulum, and toss the snow, dirt, gravel, some snow scrappers work well with the handle a bit longer, so this too, is a matter of personal preferences, depending on the shovel, push broom, grain shovel, its easier to throw the snow, sand, gravel with the non swivel hinge, because its more of a shoulder turn, rather than the second handle arm controlling the toss, better for loading sand on a trailer, etc. . . .

The benefit of this is that one can sell the hinge, swivel base plate, magnets, clamps, bolts, allowing it to be sold as kit or already assembled, as well to make use of all the spent shovel handles, saving cost to the user and the seller, etc. . . .

1) An auxiliary hinged assembly that when connected to the shaft impliment end of the shovel, it allows the user to bolt to the swivel or non swivel mode, the auxiliary hinged assembly consists of:
a) A base template base plate, it can either be made to bolt to the shovel directly, or be elongated with two 90 degree bends and clamped to the main shovel shaft.
b) The auxiliary handle can be cut to a fixed length or be designed to be an adjustible length by using different sized conduit, and using a tapered compression joint to tighten the auxiliary handle for desired length, if the conduit has iron, you will need only to secure a ceramic magnet to the main handle.
c) A hinge to bolt to the base plate, and to secure the auxiliary handle with a clamp, wood screw, or bolt.
d) A metal attraction plate bolted with a counter sunk bolt to the auxiliary handle, and a magnet glued or bolted to the main handle, if auxiliary shaft contains iron, this would replace the need for an attraction plate, if making an adjustable length handle, etc. . . .

2) The hinge is connected to the base template plate with one bolt, washer, and lock nut to be in the swivel mode, to make the hinge a non-swivel you simply add another bolt through the hinge through the base plate.
a) The hinge can be made shorter, it only needs to have two holes where it can be bolted to the base plate, and a means of attaching to the auxiliary handle to the hinge.
b) The base plate template needs to be flat, so the hinge rotates left and right, supporting the wrists because the auxiliary handle can only swivel left and right or up and down, but not clockwise or counter clockwise.
